(19) United States
(12) Patent Application Publication
(10) Pub. No.: US 2026/0035516 A1
(43) Pub. Date: Feb. 5, 2026

(54) CONDENSATION PRE-TREATMENT COMBINED WITH AN ESTERIFICATION OF LIGNIN-DERIVED MATERIAL

(71) Applicant: SixRing Inc., Calgary (CA)

(72) Inventors: Matthew Dewit, Calgary (CA); Markus Weissenberger, Calgary (CA)

(21) Appl. No.: 19/044,195

(22) Filed: Feb. 3, 2025

(30) Foreign Application Priority Data
Aug. 2, 2024 (CA) NOT YET RECEIVED

(51) Int. Cl. C08H 7/00

(52) U.S. Cl. CPC C08H 6/00

(57) ABSTRACT

A method of condensing a lignin-derived material and converting at least a portion thereof into at least one esterified lignin derivative, the method including the steps of: providing the lignin-derived material present in a LHDO composition, wherein the lignin-derived material is selected from the group consisting of: lignin monomers; lignin depolymerization products; and combinations thereof; adjusting the LHDO composition to a pH less than 1; heating the LHDO composition for a period of time sufficient to yield a heat-treated LHDO comprising at least one condensed aromatic structure; wherein the heat-treated LHDO has a higher molecular weight average than the LHDO composition; performing an esterification reaction on the heat-treated LHDO, the esterification reaction including the steps of: providing an acidic composition having a pH of less than 1, the acidic composition including an acid selected from sulfuric acid, an alkylsulfonic acid, and an arylsulfonic acid, and an alcohol selected from the group consisting of: C₁-C₈ linear alcohol and C₃-C₈ branched alcohol and mixtures thereof; combining the heat-treated LHDO with the acidic composition into an esterification reaction mixture; and heating up the esterification mixture to a temperature ranging from 25° C. to 120° C. to convert at least some of the lignin-derived material and/or the at least one condensed aromatic structure present in the heat-treated LHDO into the at least one esterified lignin derivative.

### CROSS REFERENCE TO RELATED APPLICATIONS

The current application claims priority to Canadian Application No. ______ filed Aug. 2, 2024 and titled CONDENSATION PRE-TREATMENT COMBINED WITH AN ESTERIFICATION OF LIGNIN-DERIVED MATERIAL, the contents of which are incorporated by reference in their entirety

### FIELD OF THE INVENTION

The present invention is directed to a method of converting lignin from biomass into valuable smaller chemicals, more specifically, in one instance, there is provided a method to convert lignin-derived material obtained from a modified Caro's acid delignification process into small valuable chemicals.

### BACKGROUND OF THE INVENTION

Petroleum is the cornerstone of the present chemical industry. Not only is it the most commonly used fuel in transportation, heating oils and electricity generation but it is also the primary raw material for the overwhelming majority of the basic chemicals used in plastics, adhesives and whole variety of synthetic materials just to name a few. The ever-growing demands and limits of the availability of this non-renewable resource is forcing the chemical industry to increase their research on the use of renewable resources as an alternative to petroleum.

Lignocellulosic biomass such as, but not limited to wood, grasses and other plant materials, contains three main components: cellulose fibers; lignin; and hemicelluloses. Pulping of lignocellulosic biomass has a primary goal to separate the fibers from the lignin. Lignin is a three-dimensional polymer which figuratively acts as a mortar to hold all the fibers together within the plant. Its presence in finished pulp is undesirable and adds nothing to the finished product.

Lignin accounts for, in some biomass, up to 30 percent of the lignocellulose biomass (for some biomass the lignin content can reach up to 40%), and has a great potential to replace at least a portion of the petroleum-based chemical products. However, it is still greatly underused as such an alternative. Lignin is the second most abundant organic natural material encountered in nature. However, approximately 98% of it is still simply burned to provide heat or used in the production of energy.

Lignin is made up of various aromatic compounds and its complexity comes from the diversity and degree of crosslinking between the various monomeric units which comprises it. These are called lignolsand fall under one of three main categories: coniferyl alcohol; sinapyl alcohol; and paracoumaryl alcohol.

Aromatic compounds are normally extracted from petroleum and can be used in the production of a variety of high value products including but not limited to adhesives, drugs and paints. Consequently, the potential value locked up in lignin and its various monomeric constituents is quite high as it is the only naturally occurring source of such a large number of aromatic compounds.

The depolymerization of lignin into its various constituent monomeric building blocks is a major focus of several research groups as the subsequent uses of those monomers can open the doorway to a multitude of plant-derived chemical products. The yields of the lignin-originating aromatic monomers are largely dependent on the delignification method employed as well as the biomass used. Not all biomasses contain the same lignin content. Further, since lignin is a highly complex biopolymer, its origination from different biomasses means that the ratio of the lignin-originating aromatic monomers will vary from plant to plant.

The isolation of the individual lignin-originating aromatic monomers from complex mixtures following delignification of biomass is still a substantial challenge to the industry. Lignin condensation is a particular challenge which hinders the isolation of lignin constituents. The current lignin depolymerization techniques include alkaline oxidation, fast pyrolysis (used to maximize the liquid bio-oil product yield), hydrogenolysis, and hydrolysis.

European patent application EP2025735A1 teaches a one-step conversion of solid lignin to liquid products. More specifically, a method of converting a lignin material into a liquid product by treatment in a reaction medium comprising at least one C1-C2 carboxylic acid and the liquid product obtainable by the method.

U.S. Pat. No. 9,663,835B2 discloses a process and system for the efficient fractionation of lignocellulosic biomass into cellulose, hemicellulose sugars, lignin, and acetic acid. It states that the cellulose thus obtained is highly amorphous and can be readily converted into glucose using known methods. Fermentable hemicellulose sugars, low-molecular-weight lignin, and purified acetic acid are also major products of the process and system.

United States patent application US 2010/0121110A1 discloses a method for the breakdown of lignin which teaches a method for the direct production of molecules with a minimum molecular weight of 78 g/mol by the breakdown of lignin, lignin derivatives, lignin fragments, and/or lignin-containing substances or mixtures in the presence of at least one polyoxometallate and preferably in the presence of a radical scavenger in a liquid medium.

Japanese patent application JP2015089884A teaches a method for producing lignin monomers with high yield by decomposing a plant material containing a lignin component such as wood using a reaction agent which is easily available and has no problem with handleability. The method for producing lignin monomers uses a step of irradiating a mixture with microwave of a plant material containing a lignin component and a metal compound to decompose the plant material.

United States patent application US 2013/0232853A1 discloses a method of production of biobased chemicals, biofuels, and lignin residues from lignin sources, including waste lignin. This method may allow for selectively producing biobased chemicals, biofuels, and lignin residues from lignin sources using certain processing methods. The methods for production of these biobased chemicals, biofuels, and lignin residues may be provided by chemical-induced processing, catalytic oxidative lignin depolymerization processing, and catalytic hydroprocessing. Further, the catalytic hydroprocessing from processes including catalytic reduction processing, catalytic hydrodeoxygenation processing, and/or catalytic/dehydrogenation processing may also be used. The method described herein also provides a means in which waste from the process(es) may be reduced and/or recycled.

United States patent application US2016/0130202A1 discloses methods for the production and isolation of a monomer from a biopolymer. The method includes extracting a biopolymer from a biopolymer source and depolymerizing the biopolymer into a monomer. Also disclosed are methods for the production and isolation of a monomer from corn lignin.

Because of the heterogeneity of lignin and the substantial issues caused by the condensation of lignin monomers, there has not been a satisfactory approach to extract lignin from biomass and to further convert the extracted lignin to value added chemicals. Alkali lignin is particularly susceptible to condensation reaction. Since alkaline pulping represents the most widespread delignification and pulping processes across the world, the majority of the lignin thus extracted is not salvageable for further chemical processes and is typically used as a source of heat as it is simply burned.

One of the drawbacks of the lignin obtained through a kraft delignification or through the sulfite process is largely still polymerized and thus will not be useful in generating small molecules. Pyrolysis, on the other hand, is a method to produce lignin-derived molecules from lignocellulosic biomass. Conventional pyrolysis oil generates aldehydes which can polymerize over time and thus render such bio-oil unstable over time. Most bio-oils generated from pyrolysis have the same drawbacks. Their delignification process yields bio-oil which contains aldehydes, their aldehyde content makes them unstable for long-term storage. Pyrolysis oil also has other drawbacks which include: having a high oxygen content (making them less desirable for combustion in engines); they are largely non-volatile; and they may be corrosive.

In light of the state of the art, there still exists a need for the valorization of lignin and lignin-derived materials, more specifically for a method capable of converting lignin depolymerization products into higher value chemicals.

### SUMMARY OF THE INVENTION

LHDO obtained from delignification of lignocellulosic biomass material using a modified Caro's acid, overcomes the problem caused by the presence of aldehyde by circumventing the production thereof. The oxidizing power of modified Caro's acid used favors the production of carboxylic acids and allows to achieve complete or very near to complete oxidation of the LHDO. Upon analysis, the aldehyde levels are below detection limits. According to a preferred embodiment of the present invention, the LHDO comprises lignin-derived material selected from the group consisting of: lignin monomers (20 to 50 wt. % of said lignin-derived material); lignin depolymerization products (50 to 80 wt. % of said lignin-derived material), wherein lignin depolymerization product is not a monomer but a soluble lignin-derivative, i.e. a breakdown compound.

However, a difficulty arose when wanting to extract the lignin depolymerization products present in the liquid recovered from a modified Caro's acid-driven delignification of biomass material. The various lignin monomers obtained from such a process were found to be hydrophilic and thus miscible with the remaining sulfuric acid present in the liquid recovered.

According to an aspect of the present invention, the inventors have developed a method which overcomes both the difficulties caused by the presence of a strong acid, inorganic impurities (such as sulfate salts, chlorides) and water in the liquid recovered but can also allow for the synthesis of various diester compounds and facilitate the recovery of such from a stream containing lignin depolymerization compounds as well as dissolved hemicellulose. It was surprisingly and unexpectedly discovered that a mixture of valuable aromatic and aliphatic esters could be produced from lignin-originating aromatic monomers obtained from the delignification of biomass performed using a modified Caro's acid (i.e. H₂SO₄, in the presence of a modifier and a source of peroxide).

According to one aspect of the present invention, there is provided a method to convert lignin-derived material (i.e. lignin depolymerization products comprising: lignin oligomers; and lignin monomers) into smaller molecules which are considered more valuable. According to a preferred embodiment of the present invention, the lignin-derived material obtained through the delignification of lignocellulosic feedstock (or biomass) by the methods and process disclosed herein include but are not limited to: lignin monomers; lignin depolymerization products such as: vanillic acid; malonic acid; maleic acid; succinic acid; oxalic acid; and 4-hydroxybenzoic acid. Preferably, the lignin-derived material forms part of the solubilized lignin and hemicellulose depolymerized organics (LHDO) stream resulting from a delignification of a lignocellulosic biomass through the use of a modified Caro's acid. Preferably, said lignin-hemicellulose depolymerized organics (LHDO) is a composition comprising: a strong acid and said lignin-derived material; said lignin-derived material comprises: lignin monomers (20 to 50 wt. %); lignin depolymerization products (50 to 80 wt. %).

According to an aspect of the present invention there is provided a method of condensing a lignin-derived material and converting at least a portion thereof into at least one esterified lignin derivative, said method comprising the steps of:
providing said lignin-derived material present in a LHDO composition, wherein said lignin-derived material is selected from the group consisting of: lignin monomers; lignin depolymerization products; and combinations thereof;
adjusting the LHDO composition to a pH less than 1;
heating said LHDO composition for a period of time sufficient to yield a heat-treated LHDO comprising at least one condensed aromatic structure;
   wherein said heat-treated LHDO has a higher molecular weight average than said LHDO composition;
performing an esterification reaction on said heat-treated LHDO, said esterification reaction comprising the following steps:
   providing an acidic composition having a pH of less than 1, said acidic composition comprising:
      an acid selected from the group consisting of: sulfuric acid; an alkylsulfonic acid; and an arylsulfonic acid; and
      an alcohol selected from the group consisting of: C₁-C₈ linear alcohol and C₃-C₈ branched alcohol and mixtures thereof;
   combining said heat-treated LHDO with said acidic composition into an esterification reaction mixture;
   heating up said esterification mixture to a temperature ranging from 25° C. to 120° C. to convert at least some of said lignin-derived material and/or said at least one condensed aromatic structure present in said heat-treated LHDO into said at least one esterified lignin derivative.

Preferably, the method esterifies both of said least some of said lignin-derived material and said at least one condensed aromatic structure present in said heat-treated LHDO According to a preferred embodiment of the present invention, the alcohol is selected from the group consisting of: methanol; ethanol; n-propanol; isopropanol; n-butanol; isobutanol; n-pentanol; neo-pentanol; isopentanol; isoamyl alcohol and mixtures thereof.

According to a preferred embodiment of the present invention, the alcohol and the sulfuric acid are present in a molar ratio ranging from 1.3:1 (alcohol:strong acid) to 15:1 (alcohol:strong acid). Preferably, the alcohol and the strong acid are present in a molar ratio ranging from 3:1 (alcohol:strong acid) to 5:1 (alcohol:strong acid).

According to a preferred embodiment of the present invention, the alcohol and the LHDO are present in a molar ratio ranging from 1:1 (alcohol:LHDO) to 8:1 (alcohol:LHDO). Preferably, the alcohol and the LHDO are present in a molar ratio ranging from 3:1 (alcohol:LHDO) to 5:1 (alcohol:LHDO).

According to a preferred embodiment of the present invention, the lignin-containing material results from a delignification reaction of a lignocellulosic material using a modified Caro's acid.

According to a preferred embodiment of the present invention, the heat-treated LHDO comprises at least one condensed aromatic structure and wherein said heat treated LHDO has a molecular weight average above 5000.

According to a preferred embodiment of the present invention, said at least one esterified lignin derivative is selected from the group consisting of: alkyl malonate; alkyl maleate; alkyl succinate; alkyl oxalate; dialkyl malonate; dialkyl maleate; dialkyl succinate; dialkyl oxalate; alkyl vanillate and alkylparaben. Preferably, said at least one esterified lignin derivative is selected from the group consisting of: dibutyl malonate; dibutyl maleate; dibutyl succinate; and dibutyl oxalate; butyl vanillate and butylparaben.

According to a preferred embodiment of the present invention, the alkylsulfonic acid is selected from the group consisting of: methanesulfonic acid; ethanesulfonic acid; propanesulfonic acid and combinations thereof.

According to a preferred embodiment of the present invention, the arylsulfonic acid is selected from the group consisting of: toluenesulfonic acid; benzenesulfonic acid; and combinations thereof.

According to a preferred embodiment of the present invention, the LHDO has a strong acid content ranging from 40-45%. Preferably, the strong acid is selected from the group consisting of: sulfuric acid; an alkylsulfonic acid; and an arylsulfonic acid; and combinations thereof. Preferably, the strong acid is sulfuric acid.

According to a preferred embodiment of the present invention, said lignin monomers are present in an amount ranging from 20 to 50 wt. % of said lignin-derived material According to a preferred embodiment of the present invention, lignin depolymerization products are present in an amount ranging from 50 to 80 wt. % of said lignin-derived material.

Preferably, the alcohol is selected from the group consisting of: methanol; ethanol; n-propanol; isopropanol; n-butanol; isobutanol and mixtures thereof. Preferably, where the alcohol and the sulfuric acid are present in a molar ratio ranging from 1.8:1 (alcohol:sulfuric acid) to 10:1 (alcohol:acid). More preferably, the alcohol and the sulfuric acid are present in a molar ratio ranging from 3:1 (alcohol:acid) to 5:1 (alcohol:acid). Even more preferably, lignin-containing material results from a delignification reaction of a lignocellulosic material using a modified Caro's acid.

According to a preferred embodiment of the present invention, said at least one esterified lignin derivative is selected from the group consisting of: dibutyl malonate; dibutyl maleate; dibutyl succinate; and butylparaben.

According to a preferred embodiment of the present invention, the feedstock which can be employed in the process include but is not limited to: raw & concentrated liquid Lignin-Hemicellulose-Depolymerization-Organics (LHDO); kraft lignin; alkali lignin; and the like.

### DETAILED DESCRIPTION OF THE PRESENT INVENTION

According to a preferred embodiment of the present invention, a lignocellulosic biomass feedstock is delignified using a modified Caro's acid. The resulting delignification yields a stream of cellulose and a stream of solubilized lignin and hemicellulose depolymerized organics (LHDO). Preferably, said lignin-hemicellulose depolymerized organics (LHDO) is a composition comprising: a strong acid and said lignin-derived material; said lignin-derived material comprises: lignin monomers (20 to 50 wt. %); lignin depolymerization products (50 to 80 wt. %). According to a preferred embodiment of the present invention, the LHDO comprises an acid in an amount ranging from 40-70%, preferably from 55-70% and more preferably from 60-70% (after water removal). The terms lignin depolymerization products or material may be used interchangeably herein with the term lignin oligomers, in either instance they are meant to distinguish lignin-derived material which are not considered to be lignin monomers.

According to a preferred embodiment of the present invention, the LHDO obtained from a delignification reaction of lignocellulosic biomass using a modified Caro's acid, comprises what can be considered as a bi-modal lignin-derived product distribution. There is a large concentration of compounds in the C₃-C₁₀ range and another large concentration of compounds in the C₁₂-C₃₀ range. Preferably, esterification reactions (especially with alcohols as large as butanol) are meant to increase the molecular weight of lighter lignin-derived material (such as lignin monomers) as well as react with the carboxylic acid groups and thus make them larger and less hydrophilic. Condensation reaction are also aimed at converting smaller oligomers into larger ones but can also end up grafting a smaller oligomer or lignin monomer onto an already larger molecule.

Preferably, to achieve such streams, the biomass comprising lignin, hemicellulose and cellulose fibers may be mechanically treated to reduce particle size prior to contacting it to a modified Caro's acid.

According to preferred embodiment of the present invention, the modified Caro's acid (as disclosed in Canadian patent application 3,128,678) comprises: sulfuric acid; a heterocyclic compound; and wherein sulfuric acid and said a heterocyclic compound; are present in a molar ratio of no less than 1:1. Preferably, the sulfuric acid and said heterocyclic compound are present in a molar ratio ranging from 28:1 to 2:1. More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. Preferably, the sulfuric acid and heterocyclic compound are present in a molar ratio ranging from 12:1 to 6:1. Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of: imidazole; triazole; and N-methylimidazole.

According to preferred embodiment of the present invention, the modified Caro's acid (as disclosed in Canadian patent application 3,128,677) comprises: sulfuric acid; a modifying agent comprising a compound containing an amine group; and wherein sulfuric acid and said compound containing an amine group; are present in a molar ratio of no less than 1:1. Preferably, the sulfuric acid and said compound containing an amine group are present in a molar ratio ranging from 28:1 to 2:1. More preferably, the sulfuric acid and compound containing an amine group are present in a molar ratio ranging from 24:1 to 3:1. Preferably, the sulfuric acid and compound containing an amine group are present in a molar ratio ranging from 20:1 to 4:1. More preferably, the sulfuric acid and compound containing an amine group are present in a molar ratio ranging from 16:1 to 5:1. Preferably, the sulfuric acid and compound containing an amine group are present in a molar ratio ranging from 12:1 to 6:1. According to a preferred embodiment of the present invention, the modifying agent is selected in the group consisting of: TEOA; MEOA; pyrrolidine; DEOA; ethylenediamine; diethylamine; triethylamine; morpholine; MEA-triazine; and combinations thereof. According to a more preferred embodiment of the present invention, the modifying agent is TEOA; MEOA; pyrrolidine; DEOA; ethylenediamine; triethylamine.

According to preferred embodiment of the present invention, the modified Caro's acid (as disclosed in Canadian patent application 3,128,676) comprises: sulfuric acid; a modifying agent comprising an alkanesulfonic acid; and wherein sulfuric acid and said alkanesulfonic acid are present in a molar ratio of no less than 1:1. Preferably, said alkanesulfonic acid is selected from the group consisting of: alkanesulfonic acids where the alkyl groups range from C₁-C₆ and are linear or branched; and combinations thereof. Preferably, said alkanesulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkanesulfonic acid is methanesulfonic acid. Also preferably, said alkanesulfonic acid has a molecular weight below 300 g/mol. Also preferably, said alkanesulfonic acid has a molecular weight below 150 g/mol. Preferably, the sulfuric acid and said alkanesulfonic acid and are present in a molar ratio ranging from 28:1 to 2:1. More preferably, the sulfuric acid and alkanesulfonic acid are present in a molar ratio ranging from 24:1 to 3:1. Preferably, the sulfuric acid and alkanesulfonic acid are present in a molar ratio ranging from 20:1 to 4:1. More preferably, the sulfuric acid and alkanesulfonic acid are present in a molar ratio ranging from 16:1 to 5:1. According to a preferred embodiment of the present invention, the sulfuric acid and alkanesulfonic acid are present in a molar ratio ranging from 12:1 to 6:1.

According to preferred embodiment of the present invention, the modified Caro's acid (as disclosed in Canadian patent application 3,128,675) comprises: sulfuric acid; a substituted aromatic compound; and wherein sulfuric acid and said substituted aromatic compound; are present in a molar ratio of no less than 1:1. Preferably, the substituted aromatic compound comprises at least two substituents. More preferably, at least one substituent is an amine group and at least one of the other substituent is a sulfonic acid moiety. According to a preferred embodiment, the substituted aromatic compound comprises three or more substituent. According to a preferred embodiment of the present invention, the substituted aromatic compound comprises at least a sulfonic acid moiety. According to another preferred embodiment of the present invention, the substituted aromatic compound comprises an aromatic compound having a sulfonamide substituent, where the compound can be selected from the group consisting of: benzenesulfonamides; toluenesulfonamides; substituted benzenesulfonamides; and substituted toluenesulfonamides. Preferably, the sulfuric acid and said substituted aromatic compound and are present in a molar ratio ranging from 28:1 to 2:1. More preferably, the sulfuric acid and substituted aromatic compound are present in a molar ratio ranging from 24:1 to 3:1. Preferably, the sulfuric acid and substituted aromatic compound are present in a molar ratio ranging from 20:1 to 4:1. More preferably, the sulfuric acid and substituted aromatic compound are present in a molar ratio ranging from 16:1 to 5:1. Preferably, the sulfuric acid and substituted aromatic compound are present in a molar ratio ranging from 12:1 to 6:1.

According to preferred embodiment of the present invention, the modified Caro's acid (as disclosed in Canadian patent application 3,128,674) comprises: sulfuric acid; a modifying agent comprising an arylsulfonic acid; and optionally, a compound containing an amine group; wherein sulfuric acid and said a arylsulfonic acid; are present in a molar ratio of no less than 1:1. Preferably, the compound containing an amine group is selected from the group consisting of: imidazole; N-methylimidazole; triazole; monoethanolamine (MEOA); diethanolamine (DEOA); triethanolamine (TEOA); pyrrolidine and combinations thereof. According to a preferred embodiment of the present invention, sulfuric acid and the peroxide are present in a molar ratio of approximately 1:1. Preferably, the sulfuric acid and said arylsulfonic acid and are present in a molar ratio ranging from 28:1 to 2:1. More preferably, the sulfuric acid and arylsulfonic acid are present in a molar ratio ranging from 24:1 to 3:1. Preferably, the sulfuric acid and arylsulfonic acid are present in a molar ratio ranging from 20:1 to 4:1. More preferably, the sulfuric acid and arylsulfonic acid are present in a molar ratio ranging from 16:1 to 5:1. According to a preferred embodiment of the present invention, the sulfuric acid and arylsulfonic acid are present in a molar ratio ranging from 12:1 to 6:1. Also preferably, said arylsulfonic acid has a molecular weight below 300 g/mol. Also preferably, said arylsulfonic acid has a molecular weight below 150 g/mol. Even more preferably, said arylsulfonic acid is selected from the group consisting of: orthanilic acid; metanilic acid; sulfanilic acid; toluenesulfonic acid; benzenesulfonic acid; and combinations thereof.

According to preferred embodiment of the present invention, the modified Caro's acid (as disclosed in Canadian patent application 3,128,673) comprises: sulfuric acid; a heterocyclic compound; an alkanesulfonic acid; and wherein sulfuric acid and said a heterocyclic compound; are present in a molar ratio of no less than 1:1. Preferably, said aqueous acidic composition comprising: sulfuric acid; a heterocyclic compound; an arylsulfonic acid; and wherein sulfuric acid and said a heterocyclic compound; are present in a molar ratio of no less than 1:1. Preferably, the arylsulfonic acid is toluenesulfonic acid.

Preferably, the sulfuric acid, the heterocyclic compound and the alkanesulfonic acid are present in a molar ratio ranging from 28:1:1 to 2:1:1. More preferably, the sulfuric acid the heterocyclic compound and the alkanesulfonic acid are present in a molar ratio ranging from 24:1:1 to 3:1:1. Preferably, the sulfuric acid, the heterocyclic compound and the alkanesulfonic acid are present in a molar ratio ranging from 20:1:1 to 4:1:1. More preferably, the sulfuric acid, the heterocyclic compound and the alkanesulfonic acid are present in a molar ratio ranging from 16:1:1 to 5:1:1. According to a preferred embodiment of the present invention, the sulfuric acid and heterocyclic compound are present in a molar ratio ranging from 12:1:1 to 6:1:1. Also preferably, said heterocyclic compound has a molecular weight below 300 g/mol. Also preferably, said heterocyclic compound has a molecular weight below 150 g/mol. Even more preferably, said heterocyclic compound is selected from the group consisting of: imidazole; triazole; n-methylimidazole; and combinations thereof. Preferably, the alkanesulfonic acid is selected from the group consisting of:
alkylsulfonic acids where the alkyl groups range from C₁-C₆ and are linear or branched; and combinations thereof. Preferably, said alkylsulfonic acid is selected from the group consisting of:
methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. More preferably, said alkylsulfonic acid is methanesulfonic acid.

According to preferred embodiment of the present invention, the modified Caro's acid (as disclosed in Canadian patent application 3,128,672) comprises: sulfuric acid; a carbonyl-containing nitrogenous base compound; and wherein sulfuric acid and said a carbonyl-containing nitrogenous base compound; are present in a molar ratio of no less than 1:1. According to a preferred embodiment of the present invention, the carbonyl-containing nitrogenous base compound is selected from the group consisting of: caffeine; lysine; creatine; glutamine; creatinine; 4-aminobenzoic acid; glycine; NMP (N-methyl-2-pyrrolidinone); histidine; DMA (N,N-dimethylacetamide); arginine; 2,3-pyridinedicarboxylic acid; hydantoin; and combinations thereof. Preferably, the sulfuric acid and said carbonyl-containing nitrogenous base compound and are present in a molar ratio ranging from 28:1 to 2:1. More preferably, the sulfuric acid and carbonyl-containing nitrogenous base compound are present in a molar ratio ranging from 24:1 to 3:1. Preferably, the sulfuric acid and carbonyl-containing nitrogenous base compound are present in a molar ratio ranging from 20:1 to 4:1. More preferably, the sulfuric acid and carbonyl-containing nitrogenous base compound are present in a molar ratio ranging from 16:1 to 5:1. According to a preferred embodiment of the present invention, the sulfuric acid and carbonyl-containing nitrogenous base compound are present in a molar ratio ranging from 12:1 to 6:1.

According to a preferred embodiment of the present invention, said lignocellulosic biomass comprising lignin, hemicellulose and cellulose is exposed to a modified Caro's acid composition having a pH ofless than 1, said modified Caro's acid composition selected from the group consisting of composition A; composition B; composition C; composition D; composition E; composition F; composition G; composition H; composition I; and composition J;
wherein said composition A comprises:
   sulfuric acid;
   a compound comprising an amine moiety and a sulfonic acid moiety; and
   a peroxide; and wherein sulfuric acid, said compound comprising an amine moiety and a sulfonic acid moiety and said peroxide are present in a molar ratio of no less than 1:1:1;
wherein said composition B comprises:
   sulfuric acid;
   a compound comprising an amine moiety;
   a compound comprising a sulfonic acid moiety; and
   a peroxide; wherein sulfuric acid and said a compound comprising an amine moiety and said compound comprising a sulfonic acid moiety are present in a molar ratio of no less than 1:1:1;
wherein said composition C comprises:
   an alkylsulfonic acid; and
   a peroxide; wherein said alkylsulfonic acid and said peroxide are present in a molar ratio of no less than 1:1;
wherein said composition D comprises:
   sulfuric acid;
   a heterocyclic compound; and
   a peroxide; and wherein sulfuric acid and said a heterocyclic compound; are present in a molar ratio of no less than 1:1;
wherein said composition E comprises:
   sulfuric acid;
   a modifying agent comprising a compound containing an amine group; and
   a peroxide; and wherein sulfuric acid and said compound containing an amine group; are present in a molar ratio of no less than 1:1;
wherein said composition F comprises:
   sulfuric acid;
   a modifying agent comprising an alkanesulfonic acid and
   a peroxide; and wherein sulfuric acid and said alkanesulfonic acid are present in a molar ratio of no less than 1:1;
wherein said composition G comprises:
   sulfuric acid;
   a substituted aromatic compound; and
   a peroxide; and wherein sulfuric acid and said substituted aromatic compound; are present in a molar ratio of no less than 1:1;
wherein said composition H comprises:
   sulfuric acid;
   a modifying agent comprising an arylsulfonic acid;
   a peroxide; and
   optionally, a compound containing an amine group; wherein sulfuric acid and said arylsulfonic acid are present in a molar ratio of no less than 1:1;
wherein said composition I comprises:
   sulfuric acid;
   a heterocyclic compound;
   an alkanesulfonic acid; and
   a peroxide; and wherein sulfuric acid and said a heterocyclic compound; are present in a molar ratio of no less than 1:1;
wherein said composition J comprises:
   sulfuric acid;
   a carbonyl-containing nitrogenous base compound; and
   a peroxide; and wherein sulfuric acid and said a carbonyl-containing nitrogenous base compound; are present in a molar ratio of no less than 1:1.

According to a preferred embodiment of the present invention, the lignocellulosic biomass mixture comprising hemicellulose, lignin, and cellulose is exposed to a modified Caro's acid composition at a temperature and for a period of time sufficient to a delignification reaction to occur and remove over 98.5% wt. of said lignin and over 70% wt. of the hemicellulose in a liquid stream preferably leaving in solid form most of the cellulose from said biomass.

Preferably, said compound comprising an amine moiety and a sulfonic acid moiety is selected from the group consisting of taurine; taurine derivatives; and taurine-related compounds.

Preferably, exposing said biomass to said modified Caro's acid composition will allow the delignification reaction to occur and remove over 90 wt % of said lignin and hemicellulose from said biomass. Preferably, the delignification reaction is carried out at a temperature below 55° C. by a method selected from the group consisting of:
adding water into said vessel;
adding biomass into said vessel; and
using a heat exchanger.

Preferably, said sulfuric acid, said compound comprising an amine moiety and a sulfonic acid moiety and said peroxide are present in a molar ratio of no less than 1:1:1. Also preferably, said sulfuric acid, said compound comprising an amine moiety and a sulfonic acid moiety and said peroxide are present in a molar ratio of no more than 15:1:1. Preferably, said sulfuric acid and said compound comprising an amine moiety and a sulfonic acid moiety are present in a molar ratio of no less than 3:1.

Preferably, said modifier compound comprising an amine moiety and a sulfonic acid moiety is selected from the group consisting of: taurine; taurine derivatives; and taurine-related compounds. Preferably, said taurine derivative or taurine-related compound is selected from the group consisting of: taurolidine; taurocholic acid; tauroselcholic acid; tauromustine; 5-taurinomethyluridine and 5-taurinomethyl-2-thiouridine; homotaurine (tramiprosate); acamprosate; and taurates; as well as aminoalkylsulfonic acids where the alkyl is selected from the group consisting of C₁-C₅ linear alkyl and C₁-C₅ branched alkyl. Preferably, said linear alkylaminosulfonic acid is selected form the group consisting of: methyl; ethyl (taurine); propyl; and butyl. Preferably, said branched aminoalkylsulfonic acid is selected from the group consisting of: isopropyl; isobutyl; and isopentyl.

Preferably, said sulfuric acid and compound comprising an amine moiety and a sulfonic acid moiety are present in a molar ratio of no less than 3:1.

Preferably, said compound comprising an amine moiety is an alkanolamine is selected from the group consisting of: monoethanolamine; diethanolamine; triethanolamine; and combinations thereof.

Preferably, said compound comprising a sulfonic acid moiety is selected from the group consisting of: alkylsulfonic acids and combinations thereof. More preferably, said alkylsulfonic acid is selected from the group consisting of: alkylsulfonic acids where the alkyl groups range from C₁-C₆ and are linear or branched; and combinations thereof. Yet even more preferably, said alkylsulfonic acid is selected from the group consisting of: methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof.

Also preferably, said alkylsulfonic acid; and said peroxide are present in a molar ratio of no less than 1:1. Preferably, said compound comprising a sulfonic acid moiety is methanesulfonic acid.

Preferably, in Composition C, said sulfuric acid and said a compound comprising an amine moiety and said compound comprising a sulfonic acid moiety are present in a molar ratio of no less than 1:1:1. More preferably, in Composition C, said sulfuric acid, said compound comprising an amine moiety and said compound comprising a sulfonic acid moiety are present in a molar ratio ranging from 28:1:1 to 2:1:1.

According to a preferred embodiment of the present invention, the alcohol is selected from the group consisting of: C₁-C₈ linear alcohols and C₃-C₈ branched alcohols and mixtures thereof. Preferably, the alcohol is selected from the group consisting of: isoamyl alcohol, 2-butanol, isobutyl alcohol, 2-ethylhexanol, 2-octanol; methanol, ethanol, n-propanol, isopropanol, n-butanol, n-hexanol, n-octanol. More preferably, the alcohol is selected from the group consisting of: methanol, ethanol, n-propanol, isopropanol, n-butanol, n-hexanol, n-octanol and combinations thereof.

According to a preferred embodiment of the present invention, the ratio of alcohol:feedstock is present in a weight ratio ranges from 0.5:1 to 8:1. More preferably, the alcohol:feedstock weight ratio ranges from 1:1 to 6:1. Even more preferably, the alcohol:feedstock weight ratio ranges from 2:1 to 4:1. According to a preferred embodiment of the present invention, the ratio of alcohol:feedstock is present in a weight ratio of 3:1.

According to a preferred embodiment of the present invention, the duration of the reaction is up to 3 hours. According to another preferred embodiment of the present invention, the duration of the reaction is up to 6 hours. According to yet another preferred embodiment of the present invention, the duration of the reaction is up to 18 hours. According to yet another preferred embodiment of the present invention, the duration of the reaction is up to 24 hours.

According to a preferred embodiment of the present invention, the reaction is carried out at a temperature of 25° C. According to another preferred embodiment of the present invention, the reaction is carried out at a temperature of up to 40° C. According to another preferred embodiment of the present invention, the reaction is carried out at a temperature of up to 60° C. According to another preferred embodiment of the present invention, the reaction is carried out at a temperature of up to 80° C. According to another preferred embodiment of the present invention, the reaction is carried out at a temperature of up to 100° C. According to another preferred embodiment of the present invention, the reaction is carried out at a temperature of up to 120° C.

LHDO feedstock obtained from a delignification of lignocellulosic biomass using a modified Caro's acid contains: dissolved lignin (present as: lignin monomers; lignin depolymerization products; and a combination thereof); dissolved hemicellulose; strong acid; inorganic impurities (such as sulfate salts, chlorides); and water.

According to a preferred embodiment of the present invention, the condensation reaction is carried out to allow the LHDO to undergo acid-catalyzed condensation reactions and increase the amount/size of the “heavy phase”, which consists of condensed aromantics. Preferably, the raw LHDO obtained from the delignification reaction is rotavapped to remove as much water as possible. LHDO concentrate aims to reduce to presence of water and compared to the concentrate, it contains 30-40% less water. Of course, more water can be removed from the LHDO feedstock but as a cost to the overall process, the costs related water removal must be considered versus the benefit. Water removal has several benefits which include a more efficient esterification step as there is less water to impede the reaction.

The resulting LHDO concentrate has a pH below 1. The LHDO concentrate was then stirred for 24 hours at either 25 or 50° C.

Following this condensation step, an esterification reaction was performed on the condensed LHDO. After isolation of the esterified LHDO, hexanes were added, which dissolved (or separated) the most hydrophobic portion of the LHDO, leaving behind the less hydrophobic portion. Previously, it had been determined that the hexane extraction step was able to dissolve all of the small molecules (diester compounds and aromatic monomers) along with a small amount of condensed aromatics. Based on that knowledge, it was expected that if the amount of condensed aromatics was increased in the sample (through condensation reaction) then there should be less hexane-soluble material in the final product. However, this was not the case, and it was determined that the final product contained more hexanes-soluble material. It is believed that the condensation reaction occurred as expected but this also led to a lower oxygen content which was sufficient for at least some of the condensed aromatics to become soluble in the hexane solvent.

Yield values are expressed in terms of percentage of dissolved lignin and hemicellulose that gets esterified and converted into the bio-oil. Higher yields mean a greater percentage of the material as a whole gets converted into partially or fully esterified LHDO and becomes organic-soluble. Water content indicates how hydrophobic that material is. Even though the material is organic-soluble it can still be somewhat hydrophilic. Lower water content indicates a more hydrophobic product, while higher water content indicates less hydrophobic product. Preferably, lower water content is desirable.

Total Acid Number (TAN) gives an indication of the efficiency of the reaction. The definition of TAN is the mass in mg of KOH required to neutralize 1 g of oil, which means that the more acid the oil contains, the higher the TAN value will be. The starting LHDO contains a of lot of carboxylic acid compounds and would therefore have a very high TAN value (above 500). As these acids get converted into esters, they no longer react with KOH and so the TAN value will decrease, and so the more acid groups that get converted into esters, the lower the TAN value of the finished product will be. Lower TAN value means fewer carboxylic acids in the finished product which, in turn, means greater conversion efficiency. Yield values: above 60% is excellent, 50-60% is good, 30-50% is moderate, below 30% is poor. Water content values: above 1.5% is poor, between 0.5-1.5% is moderate, between 0.5-0.2% is good, below 0.2% is excellent. TAN values: above 150 is poor, between 100-150 is moderate, between 50-100 is good (matches pyrolysis oil), below 50 is excellent.

### Experimental

Either 50 or 100 g of raw LHDO was added to a round bottom flask, and the mixture was rotavapped to remove as much water as possible, and then the residue was weighed. The concentration of sulfuric acid during the pretreatment step was 63%.

The flask was then placed in an oil bath on a heating stir plate, and the oil bath temperature was set to 25, 50, 75 or 100° C. The mixture was then left to stir for 3-72 hours. Preferably, the period of time for the pre-treatment is pre-determined and is expected to coincide, in most cases, with a colour change (darkening of the solution may be observed). In many cases, this has been determined to be roughly 18 hours.

After the pretreatment time had elapsed, the required amount of butanol was added to the mixture to obtain a 1:1 weight ratio of butanol:LHDO, and then an air condenser was attached and the mixture was heated to 55° C. and stirred for 18 hours. The flask was cooled, and the mixture was filtered through a fritted filter to remove precipitated solids. The solids were rinsed with additional butanol, collected, and dried in an oven overnight at 50° C. The filtrate was collected and transferred to a roundbottom flask, and then the butanol was removed on a rotavap. The residue was transferred to a separatory funnel and ethyl acetate and water were added. The mixture was shaken vigorously and then left to separate. The ethyl acetate phase was collected, and the aqueous phase was extracted a second time with fresh ethyl acetate. The ethyl acetate phases were combined and then poured back into a separatory funnel, and pH 3.5 sulfate buffer solution was added. The mixture was shaken vigorously and then left to separate. The ethyl acetate layer was collected, dried with magnesium sulfate, filtered, and then rotavapped to remove the ethyl acetate, yielding esterified LHDO as an oil.

The oil was characterized by NMR, acid-base titrations and Karl-Fischer titrations to determine water content. The remaining oil was mixed with an equal mass of hexanes and shaken vigorously, then left to separate. The hexanes solution was removed, fresh hexanes added, and the process repeated. The hexanes solutions were combined, rotavapped and weighed to determine the percentage of hydrophobic material present in the oil. The hexanes-insoluble portion was then rotavapped as well to remove any residual solvent, and then analyzed by gel permeation chromatography to measure the molecular weight distribution of the material.

TABLE 1
Yields of experiments carried out according to a preferred embodiment of the present invention
at 55° C. for a period of 18 hours with various pre-treatment times and temperatures

| | | | % Yield Based | | | | Hexane- | |
|---|---|---|---|---|---|---|---|---|
| Pretreatment | Pretreatment | BuOH:LHDO | on Lignin & | % | | | soluble | Est'd MW |
| Time | temp | ratio | Hemicellulose | H2O | SAN | TAN | Fraction | by GPC |
| 24 h | 25 C. | 1:1 | 62.19 | 0.05 | 12.23 | 21.28 | 52.8% | 5384 |
| 24 h | 50 C. | 1:1 | 60.97 | 0.04 | 14.39 | 28.25 | 48.8% | 18160 |
| N/A | N/A | 1:1 | 63.40 | 0.03 | 13.77 | 23.72 | 43.8% | 4730 |

The data summarized in table 1 indicates that esterification on the LHDO which had been exposed to a condensation pre-treatment by acid exposure at a pH less than 1, yielded a higher percentage of hexane-soluble compounds than the composition which had not had a pre-treatment step. It was further established through gel permeation chromatography that the pre-treated material (also referred to as heat-treated material) contained species that had more than tripled in molecular weight versus species found in the composition which had not been pre-treated (control composition).

TABLE 2
Yields of experiments carried out according to a preferred embodiment of the present
invention where the pre-treatment duration and temperature are varied and where
the esterification was carried out in a BuOH:LHDO ratio of 1:1 at 55° C.
for a period of 18 hours with various pre-treatment times and temperatures

| | | | | % Yield | | | | | |
|---|---|---|---|---|---|---|---|---|---|
| | | | | Based on | | | | Hexane- | |
| Pretreatment | | Pretreatment | | Lignin & | % | | | soluble | Est'd MW |
| Time | | temp | | Hemicellulose | H₂O | SAN | TAN | Fraction | by GPC |
| 3 | h | 25 | C. | 61.21% | 0.007 | 16.09 | 29.24 | 50.42 | 3968 |
| 3 | h | 50 | C. | 63.48% | 0.07 | 15.65 | 34.65 | 49.26 | 5194 |
| 6 | h | 25 | C. | 60.98% | 0.05 | 16.42 | 25.51 | 48.20 | 4157 |
| 6 | h | 50 | C. | 62.72% | 0.06 | 15.27 | 32.59 | 46.85 | 12730 |
| 18 | h | 25 | C. | 65.00% | 0.06 | 12.56 | 30.17 | 48.96 | 4151 |
| 18 | h | 50 | C. | 64.59% | 0.02 | 13.43 | 41.10 | 32.31 | 14940 |
| 72 | h | 25 | C. | 57.74% | 0.002 | 15.72 | 32.8 | 52.17 | 4310 |
| 72 | h | 50 | C. | 60.61% | 0.002 | 13.32 | 39.45 | 51.43 | 15890 |
| 3 | h | 100 | C. | 57.58% | 0.045 | 11.37 | 35.98 | 40.63 | 16760 |
| 3 | h | 75 | C. | 61.31% | 0.04 | 16.69 | 30.34 | 47.41 | 16540 |

| | | | | | | | |
|---|---|---|---|---|---|---|---|
| N/A | N/A | 60.75% | 0.01 | 17.03 | 32.32 | 50.51 | 4076 |

The data summarized in table 2 indicates that esterification on the LHDO which had been exposed to a condensation pre-treatment by acid exposure yielded substantially larger molecules (as determined by GPC when taking into account average molecular weight) when higher temperatures and/or longer reaction times were used. The results reported in Table 2 indicate that temperature of the pre-treatment is a slightly bigger contributor to condensation than the duration of pre-treatment.

The compounds obtained from the process according to a preferred embodiment of the present invention can potentially be used for the following applications: resins, corrosion inhibitors, lubricants and viscosifiers. This is not a comprehensive list, these are just the some first uses to which such compounds can be immediately applied.

When used in this specification and claims, the terms “comprises” and “comprising” and variations thereof mean that the specified features, steps or integers are included. The terms are not to be interpreted to exclude the presence of other features, steps or components. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A method of condensing a lignin-derived material and converting at least a portion thereof into at least one esterified lignin derivative, said method comprising the steps of:
providing said lignin-derived material present in a LHDO composition, wherein said lignin-derived material is selected from the group consisting of: lignin monomers; lignin depolymerization products; and combinations thereof;
adjusting the LHDO composition to a pH less than 1;
heating said LHDO composition for a period of time sufficient to yield a heat-treated LHDO comprising at least one condensed aromatic structure;
wherein said heat-treated LHDO has a higher molecular weight average than said LHDO composition;
performing an esterification reaction on said heat-treated LHDO, said esterification reaction comprising the following steps:
providing an acidic composition having a pH of less than 1, said acidic composition comprising:
an acid selected from the group consisting of: sulfuric acid; an alkylsulfonic acid;
and an arylsulfonic acid; and
an alcohol selected from the group consisting of: C₁-C₈ linear alcohol and C₃-C₈ branched alcohol and mixtures thereof;
combining said heat-treated LHDO with said acidic composition into an esterification reaction mixture; and
heating up said esterification mixture to a temperature ranging from 25° C. to 120° C. to
convert at least some of said lignin-derived material and/or said at least one condensed aromatic
structure present in said heat-treated LHDO into said at least one esterified lignin derivative.

2. The method according to claim 1, wherein the alcohol is selected from the group consisting of: methanol; ethanol; n-propanol; isopropanol; n-butanol; isobutanol; n-pentanol; neo-pentanol; isopentanol; isoamyl alcohol and mixtures thereof.

3. The method according to claim 1, wherein the alcohol and the sulfuric acid are present in a molar ratio ranging from 1.3:1 (alcohol:strong acid) to 15:1 (alcohol:strong acid).

4. The method according to claim 1, wherein the alcohol and the strong acid are present in a molar ratio ranging from 3:1 (alcohol:strong acid) to 5:1 (alcohol:strong acid).

5. The method according to claim 1, wherein the alcohol and the LHDO are present in a molar ratio ranging from 1:1 (alcohol:LHDO) to 8:1 (alcohol:LHDO).

6. The method according to claim 1, wherein the alcohol and the LHDO are present in a molar ratio ranging from 3:1 (alcohol:LHDO) to 5:1 (alcohol:LHDO).

7. The method according to claim 1, wherein said lignin-derived material results from a delignification reaction of a lignocellulosic material using a modified Caro's acid.

8. The method according to claim 1, wherein said at least one esterified lignin derivative is selected from the group consisting of: alkyl malonate; alkyl maleate; alkyl succinate; alkyl oxalate; dialkyl malonate; dialkyl maleate; dialkyl succinate; dialkyl oxalate; alkyl vanillate and alkylparaben.

9. The method according to claim 8, wherein said at least one esterified lignin derivative is selected from the group consisting of: dibutyl malonate; dibutyl maleate; dibutyl succinate; and dibutyl oxalate; ethyl vanillate and ethylparaben.

10. The method according to claim 1, wherein the alkylsulfonic acid is selected from the group consisting of: methanesulfonic acid; ethanesulfonic acid; propanesulfonic acid and combinations thereof.

11. The method according to claim 1, wherein the arylsulfonic acid is selected from the group consisting of: toluenesulfonic acid; benzenesulfonic acid; and combinations thereof.

12. The method according to claim 1, wherein the LHDO has a strong acid content ranging from 25-50%.

13. The method according to claim 1, wherein the LHDO has a strong acid content ranging from 40-45%.

14. The method according to claim 1, wherein the strong acid is selected from the group consisting of: sulfuric acid; an alkylsulfonic acid; and an arylsulfonic acid; and combinations thereof.

15. The method according to claim 13, wherein the strong acid is sulfuric acid.

16. The method according to claim 1, wherein said lignin monomers are present in an amount ranging from 20 to 50 wt. % of said lignin-derived material

17. The method according to claim 1, wherein said lignin depolymerization products are present in an amount ranging from 50 to 80 wt. % of said lignin-derived material.

18. The method according to claim 1, wherein said heat-treated LHDO has a molecular weight average above 5000.
